(19) United States
(12) Patent Application Publication
(10) Pub. No.: US 2015/0370406 A1
(43) Pub. Date: Dec. 24, 2015

(54) PROTECTIVE FILM, PROTECTIVE GLASS AND COMMUNICATION METHOD OF MOBILE PHONE

(71) Applicant: Yue Zhao, Shenzhen (CN)

(72) Inventor: Yue Zhao, Shenzhen (CN)

(21) Appl. No.: 14/761,500

(22) PCT Filed: Dec. 23, 2014
(86) PCT No.: PCT/CN2014/094705

§ 371 Date: Sep. 9, 2015

(30) Foreign Application Priority Data
May 4, 2014 (CN) 201410184533X

(51) Int. Cl. G06F 3/041; H04B 1/3888; B32B 9/00; G06F 3/0481; G06F 1/16; G06F 3/0488; H04M 1/725; G06F 3/044

(52) U.S. Cl. CPC G06F 3/0416; H04M 1/72569; H04B 1/3888; G06F 3/0412; G06F 3/044; G06F 3/04817; G06F 1/1643; G06F 3/0488; B32B 9/00; B32B 2250/04; B32B 2457/20

(57) ABSTRACT

The present invention discloses a method for communicatively connecting a protective film/glass and a mobile phone comprising: downloading and installing a mobile phone APP by a user; implanting one or more APP hidden icons to an edge of the display window of the mobile phone touch screen or an area without action icon by the mobile phone APP; attaching the protective film/glass to the mobile phone touch screen; producing touch buttons on the protective film/glass corresponding to a touching-reactionless portion of an upper end or a lower end of a mobile phone touch screen; touching one of the touch buttons, which makes the capacitance of the hidden icon on the mobile phone touch screen changed; waking up or exiting the mobile phone APP quickly and conveniently through the input and output of CPU. Besides a series of traditional uses such as improving of perverting scoring and polluting for mobile phone, through developing mobile phone system, the present invention enables user download APP according their requirements easily, operate a portion of a mobile phone touch screen that is touching-reactionless originally, wake up or exit commonly used application quickly and conveniently, thereby the application area of the mobile phone is enlarged, user experience and playability are improved.

### TECHNICAL FILED

The present invention relates to a technical field of mobile phone accessory, especially relates to a protective film/glass, and a method for communicatively connecting a protective film/glass and a mobile phone.

### BACKGROUND OF THE INVENTION

From traditional PC to present mobile terminal, mobile phone plays a more and more important role, besides basic communication functions such as short message, call and chat, people also use mobile phone to carry out various work and entertainment activities such as processing documents, watching TV and playing game. But the present mobile phone screen has only one visible surface, when an activity is carried out on a mobile phone screen, especially such as playing game, reading article, watching video, the mobile phone screen will be fully occupied, if a short message or a call is received at this moment, the present activity must be exited temporarily in order to switch to short message or call manually, and the previous full screen page is continued manually after finishing the short message or call, thus this is not only inconvenient, but also time-consuming and has poor operation experience.

### SUMMARY OF THE INVENTION

The present invention aims at providing a method for communicatively connecting a protective film/glass and a mobile phone, which can conveniently extend a fine touch operation for the mobile phone touch screen to a touch operation for a touch button outside the mobile screen, so that waking up or exiting of the commonly used application is quickly realized, and application area of a mobile phone is enlarged.

To achieve above purpose, the technical solutions provided in the present invention are:

Firstly, providing a method for communicatively connecting for a protective film/glass and a mobile phone, comprising:

(1) downloading and installing a mobile phone APP developed specifically for a mobile phone operating system by a user according to the type of the mobile phone and the network type; implanting one or more APP hidden icons to an edge of the display window of the mobile phone touch screen or an area without action icon by the mobile phone APP, wherein the APP hidden icon is corresponding to a trigger point on the mobile phone touch screen; touching the trigger point and the APP hidden icon to complete an application function set by the mobile phone APP;

(2) attaching the protective film/glass to the mobile phone touch screen; producing one or more transparent conductive touch buttons at unfixed positions on the protective film/glass corresponding to a touching-reactionless portion of an upper end or a lower end of a mobile phone touch screen; producing an induction electrode at an area of the protective film/glass corresponding to the position of the hidden icon and the trigger point on the mobile phone screen in method (1); connecting the trigger points with one or more touch buttons respectively by very thin transparent wire; touching one of the touch button, which makes the capacitance between the induction electrode on the protective film/glass and the trigger point on the mobile phone touch screen changed, so as to complete an application function set by the corresponding mobile phone APP in method (1).

In the method for communicatively connecting a protective film/glass and a mobile phone, the protective film/glass consists of 4 material layers made of transparent materials, which from lower to upper are a silica gel layer, a conductive layer, a base material layer and a hardened layer; the touch button, the induction electrode and the very thin transparent wire on the protective film/glass are all made of transparent material, which is specially ITO or transparent conductive polymer, and which is produced by printing or photoetching after plating film.

In the method for communicatively connecting a protective film/glass and a mobile phone, the induction electrode on the protective film/glass is corresponding to the position of the hidden APP icon or the trigger point, whose size is not larger than a finger touch area of a normal person, so that does not affect normal finger touch action to the mobile phone touch screen.

Secondly, providing a protective film/glass, the protective film/glass consists of 4 material layers made of transparent materials, which from lower to upper are a silica gel layer, a conductive layer, a base material layer and a hardened layer, the protective film/glass is correspondingly attached on a mobile phone touch screen, a touch button and an induction electrode are arranged at unfixed positions, wherein one or more touch buttons are arranged at unfixed positions on the protective film/glass corresponding to a touching-reactionless portion of an upper end or a lower end of a mobile phone touch screen, one or more induction electrode are arranged at unfixed positions in the display window of the protective film/glass, and the touch button is connected to the induction electrode through a very thin transparent wire.

In the protective film/glass, a trigger point is arranged at an unfixed position in the display window of the mobile phone touch screen, the induction electrode in the protective film/glass is mutually induced with the trigger point in the mobile phone touch screen, the capacitance between the induction electrode on the protective film/glass and the trigger point on the mobile phone touch screen is changed by touching the touch button on the protective film/glass so as to complete a or a series of functions of a mobile phone.

In the protective film/glass, the touch button, the induction electrode and the very thin transparent wire on the protective film/glass are all made of transparent material which is specifically ITO or transparent conductive polymer, and which is produced by printing or photoetching after plating film.

In the protective film/glass, the very thin transparent wire crosses over multiple touch lines of the mobile phone touch screen, the very thin transparent wire does not cause electromagnetic shielding to the crossed part, and does not affect normal finger touch to the mobile phone touch screen.

In the protective film/glass, the induction electrode on the protective film/glass is corresponding to the position of the trigger point, whose size is not larger than a finger touch area of a normal person, so that does not affect normal finger touch action to the mobile phone touch screen.

Compared with prior art, the beneficial effect of the present invention is that: besides a series of traditional uses such as improving of perverting scoring and polluting for mobile phone through attaching the protective film/glass on the mobile phone, in the present application, one or more touch buttons are arranges on the protective film/glass outside the area of the mobile phone touch screen, the touch buttons are connected to the mobile phone touch screen by very thin wires in an internal layer of the protective film, a touch operation for a very fine and small region of the mobile phone touch screen can be extended to a touch operation for a touch button outside the mobile phone touch screen conveniently by touching the touch button, so that the normal operations for touch screen are not affected, user can download and set the APP according to requirement, operate the portion of the display window of the mobile phone which is touching-reactionless originally, the application area of the mobile phone is enlarged, thereby operating time is saved, operating complexity is reduced, user experience and the playability are improved.

The present invention will be more apparent from the following description in combination with the accompanying drawings, which are used to explain the embodiments of the present invention.

### BRIEF DESCRIPTION OF THE DRAWINGS

FIG. 1 is a layered structure schematic diagram of a protective film or a protective glass in an embodiment of the present invention;

FIG. 2 is a schematic diagram of a mobile phone touch screen and trigger points in an embodiment of the present invention;

FIG. 3 is a schematic diagram of a protective film or a conductive layer of a protective glass in an embodiment of the present invention.

### DETAILED DESCRIPTION

The embodiments of the present invention are described with reference to the drawings, in which similar components are marked with the same reference numbers.

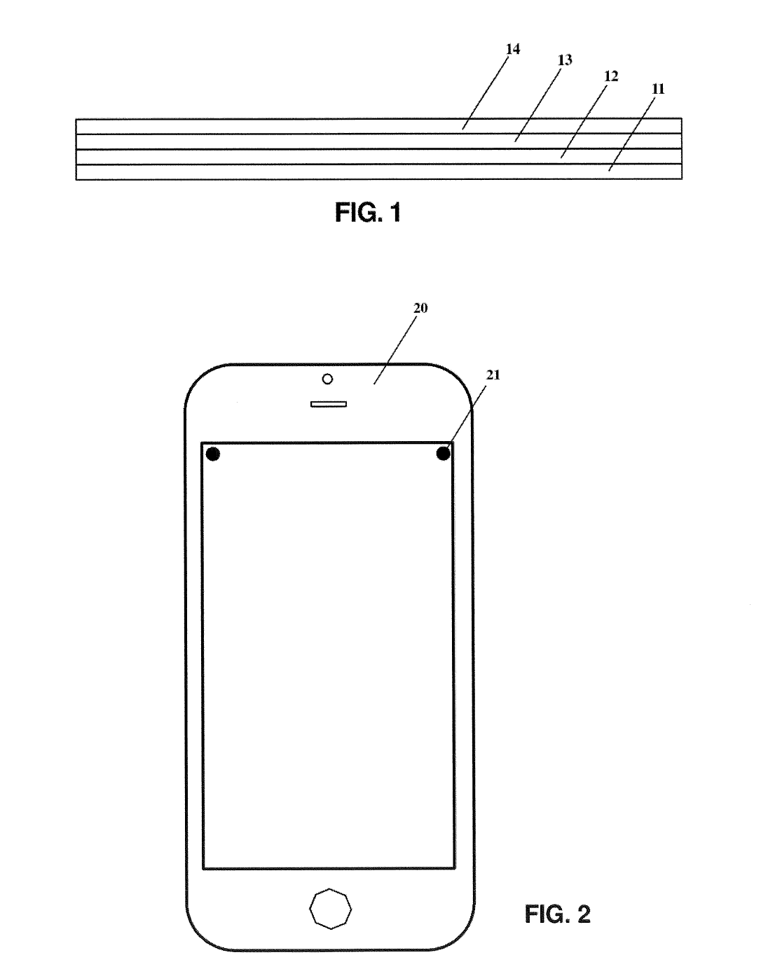

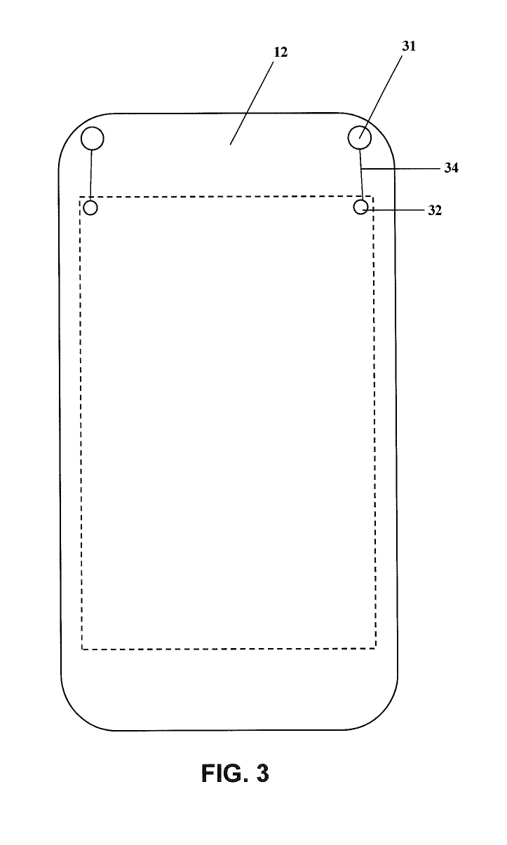

Refers to FIG. 1, FIG. 2 and FIG. 3, firstly the embodiment of the present invention provides a protective film/glass, the protective film/glass consists of 4 material layers made of transparent materials, which from lower to upper are a silica gel layer 11, a conductive layer 12, a base material layer 13 and a hardened layer 14, the protective film/glass is correspondingly attached on a mobile phone touch screen 20, a touch button 31 and an induction electrode 32 are arranged at unfixed positions, wherein one or more touch buttons are arranged at unfixed positions on the protective film/glass corresponding to a touching-reactionless portion of an upper end or a lower end of a mobile phone touch screen 20, one or more induction electrode 31 are arranged at unfixed positions in the display window of the protective film/glass, and the touch button 31 is connected to the induction electrode 32 through a very thin transparent wire 34.

In the protective film/glass, a trigger point 21 is arranged at an unfixed position in the display window of the mobile phone touch screen 20, the induction electrode 32 in the protective film/glass is mutually induced with the trigger point 21 in the mobile phone touch screen 20, the capacitance between the induction electrode 32 on the protective film/glass and the trigger point 21 on the mobile phone touch screen is changed by touching the touch button 31 on the protective film/glass so as to complete a or a series of functions of a mobile phone.

In the protective film/glass, the touch button 31, the induction electrode 32 and the very thin transparent wire 34 on the protective film/glass are all made of transparent material which is specifically ITO or transparent conductive polymer, and which is produced by printing or photoetching after plating film.

In the protective film/glass, the very thin transparent wire 34 crosses over multiple touch lines of the mobile phone touch screen, the very thin transparent wire 34 does not cause electromagnetic shielding to the crossed part, and does not affect normal finger touch to the mobile phone touch screen.

In the protective film/glass, the induction electrode 32 on the protective film/glass is corresponding to the position of the trigger point, whose size is not larger than a finger touch area of a normal person, so that does not affect normal finger touch action to the mobile phone touch screen.

The present embodiment also provides a method for communicatively connecting a protective film/glass and a mobile phone, comprising:

(1) downloading and installing a mobile phone APP developed specifically for a mobile phone operating system by a user according to the type of the mobile phone and the network type; implanting one or more APP hidden icons to an edge of the display window of the mobile phone touch screen or an area without action icon by the mobile phone APP, wherein the APP hidden icon is corresponding to a trigger point on the mobile phone touch screen; touching the trigger point and the APP hidden icon to complete an application function set by the mobile phone APP;

(2) attaching the protective film/glass to the mobile phone touch screen; producing one or more transparent conductive touch buttons at unfixed positions on the protective film/glass corresponding to a touching-reactionless portion of an upper end or a lower end of a mobile phone touch screen; producing an induction electrode at an area of the protective film/glass corresponding to the position of the hidden icon and the trigger point on the mobile phone screen in method (1); connecting the trigger points with one or more touch buttons respectively by very thin transparent wire; touching one of the touch button, which makes the capacitance between the induction electrode on the protective film/glass and the trigger point on the mobile phone touch screen changed, so as to complete an application function set by the corresponding mobile phone APP in method (1).

In combination with FIG. 1-FIG. 3, besides a series of traditional uses such as improving of perverting scoring and polluting for mobile phone through attaching the protective film/glass on the mobile phone, one or more touch buttons are arranges on the protective film/glass outside the area of the mobile phone touch screen, the touch buttons are connected to the mobile phone touch screen by very thin wires in an internal layer of the protective film, a touch operation for a very fine and small region of the mobile phone touch screen can be extended to a touch operation for a touch button outside the mobile phone touch screen conveniently by touching the touch button, so that the normal operations for touch screen are not affected, user can download and set the APP according to requirement, operate the portion of the display window of the mobile phone which is touching-reactionless originally, the application area of the mobile phone is enlarged, thereby operating time is saved, operating complexity is reduced, user experience and the playability are improved.

The present invention has been described with reference to preferred embodiment thereof, the protective scope of the present invention should not limited to the above contents, therefore various equivalent modifications based on the protection scope of the present invention are also within the scope of the present invention.

What is claimed is:

1. A method for communicatively connecting a protective film/glass and a mobile phone, characterized in that, comprising:
(1) downloading and installing a mobile phone APP developed specifically for a mobile phone operating system by a user according to the type of the mobile phone and the network type; implanting one or more APP hidden icons to an edge of the display window of the mobile phone touch screen or an area without action icon by the mobile phone APP, wherein the APP hidden icon is corresponding to a trigger point on the mobile phone touch screen; touching the trigger point and the APP hidden icon to complete an application function set by the mobile phone APP;
(2) attaching the protective film/glass to the mobile phone touch screen; producing one or more transparent conductive touch buttons at unfixed positions on the protective film/glass corresponding to a touching-reactionless portion of an upper end or a lower end of a mobile phone touch screen; producing an induction electrode at an area of the protective film/glass corresponding to the position of the hidden icon and the trigger point on the mobile phone screen in method (1); connecting the trigger points with one or more touch buttons respectively by very thin transparent wire; touching one of the touch buttons, which makes the capacitance between the induction electrode on the protective film/glass and the trigger point on the mobile phone touch screen changed, so as to complete an application function set by the corresponding mobile phone APP in method (1).

2. The method for communicatively connecting a protective film/glass and a mobile phone according to claim 1, characterized in that, the protective film/glass consists of 4 material layers made of transparent materials, which from lower to upper are a silica gel layer, a conductive layer, a base material layer and a hardened layer; the touch button, the induction electrode and the very thin transparent wire on the protective film/glass are all made of transparent material, which is specially ITO or transparent conductive polymer, and which is produced by printing or photoetching after plating film.

3. The method for communicatively connecting a protective film/glass and a mobile phone according to claim 1, characterized in that, the induction electrode on the protective film/glass is corresponding to the position of the hidden APP icon or the trigger point, whose size is not larger than a finger touch area of a normal person, so that does not affect normal finger touch action to the mobile phone touch screen.

4. A protective film/glass, characterized in that, the protective film/glass consists of 4 material layers made of transparent materials, which from lower to upper are a silica gel layer, a conductive layer, a base material layer and a hardened layer, the protective film/glass is correspondingly attached on a mobile phone touch screen, a touch button and an induction electrode are arranged at unfixed positions, wherein one or more touch buttons are arranged at unfixed positions on the protective film/glass corresponding to a touching-reactionless portion of an upper end or a lower end of a mobile phone touch screen, one or more induction electrode are arranged at unfixed positions in the display window of the protective film/glass, and the touch button is connected to the induction electrode through a very thin transparent wire.

5. The protective film/glass according to claim 4, characterized in that, a trigger point is arranged at an unfixed position in the display window of the mobile phone touch screen, the induction electrode in the protective film/glass is mutually induced with the trigger point in the mobile phone touch screen, the capacitance between the induction electrode on the protective film/glass and the trigger point on the mobile phone touch screen is changed by touching the touch button on the protective film/glass so as to complete a or a series of functions of a mobile phone.

6. The protective film/glass according to claim 4, characterized in that, the touch button, the induction electrode and the very thin transparent wire on the protective film/glass are all made of transparent material which is specifically ITO or transparent conductive polymer, and which is produced by printing or photoetching after plating film.

7. The protective film/glass according to claim 4, characterized in that, the very thin transparent wire crosses over multiple touch lines of the mobile phone touch screen, the very thin transparent wire does not cause electromagnetic shielding to the crossed part, and does not affect normal finger touch to the mobile phone touch screen.

8. The protective film/glass according to claim 4, characterized in that, the induction electrode on the protective film/glass is corresponding to the position of the trigger point, whose size is not larger than a finger touch area of a normal person, so that does not affect normal finger touch action to the mobile phone touch screen.
